(19) United States
(12) Patent Application Publication
(10) Pub. No.: US 2010/0292926 A1
(43) Pub. Date: Nov. 18, 2010

(54) ROAD TOPOGRAPHIC SURVEYING SYSTEM

(75) Inventor: Chih-Hsiung Yang, Kaohsiung City (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: NATIONAL KAOHSIUNG UNIVERSITY OF APPLIED SCIENCES, Kaohsiung City (TW)

(21) Appl. No.: 12/465,324

(22) Filed: May 13, 2009

(51) Int. Cl. G06F 19/00

(52) U.S. Cl. 702/5

(57) ABSTRACT

A road topographic surveying system comprises at least a vehicle, a horizontal angle sensor, an encoder, a micro-processor, a data storage, and display. The vehicle has a wheel with a wheel radius rotatably engaged with road and coupled with the encoder. The encoder generates a rotate signal to the micro-processor at every predetermined graduations of the wheel rotation. Each time the micro-processor receives the rotate signals, acquires a instantaneous horizontal angle value from the horizontal angle sensor thereby to calculate a segment of moving length and a segment of height, and calculate an accumulated height and calculates an accumulated length, stores the accumulated length, instantaneous horizontal angle value and the accumulated height into the data storage, and display the all in the display correspondingly and sequentially.

### BACKGROUND OF THE INVENTION

1. Field of the Invention

The present invention relates generally to a topographic surveying system and device. More particularly, this invention relates to a surveying system that can move along a road surface in tunnel or deep forest for collecting the datum of height varieties of the road.

2. Description of the Related Art

Land measurement and surveying for a wide variety of projects, such as residential development, building and road construction, and other civil engineering tasks, customarily involves extensive field surveys and preparation of detailed maps illustrating large amounts of precisely measured topographic and structural data.

When combined with computers and appropriate software, measurement accuracy and economy of data analysis may be realized. However, the conventional approaches to surveying, requiring at least two people, tripod with a surveying instrument mounted thereon and a leveling rod, is not easily adaptable in light of the afore-mentioned advances in the art. Further, it would be desirable to provide protection for the surveyors and their equipment, as well as providing a faster and more accurate establishment of position of the surveying instrument.

The method and apparatus disclosed in U.S. Pat. No. 6,191,732 issued on Feb. 20, 2001, is used to determine the tree-dimensional (x, y, z) coordinate position of the receiving position of a GPS antenna on an earth-moving machine or a vehicle, which determines the tilt of the machine or vehicle in real time, and utilizes this data to calculate the three-dimensional position of a point of the earth's surface disposed beneath the machine or vehicle. While the earth-moving machine or a vehicle is entering a tunnel or deep forest, the GPS antenna will receive no further information from the satellites, and this would cause the function of the surveying system and device to be terminated immediately.

### SUMMARY OF THE INVENTION

To overcome the shortcomings, the present invention provides a road topographic surveying system that permits the road topographic surveying work to be continuing even in a tunnel or deep forest area along a determined road or path. The road topographic surveying system comprises at least a vehicle, a horizontal angle sensor, an encoder, a micro-processor, a data storage, and display.

The vehicle has a wheel with a wheel radius (R) rotatably engaged with the road and coupled with the encoder. The encoder generates a rotate signal to the micro-processor at every predetermined graduations (n°) of the wheel rotation. Each time the micro-processor receives the rotate signals, acquires a instantaneous horizontal angle value from the horizontal angle sensor thereby to calculate a segment of moving length and a segment of height, and calculates an accumulated height and calculate an accumulated length of a point, stores the accumulated length, instantaneous horizontal angle value and the accumulated height into the data storage, and display the all in the display correspondingly and sequentially.

It is to be understood that both the foregoing general description and the following detailed description are exemplary and explanatory and are intended to provide further explanation of the invention as claimed.

### BRIEF DESCRIPTION OF THE DRAWINGS

FIG. 1 is a schematic view illustrating a road topographic surveying system of the present invention which is moving along a hill road.

FIG. 2 is a schematic view illustrating elements of the road topographic surveying system of the present invention according to a preferred embodiment of the present invention.

FIG. 3 is a schematic view illustrating elements of the road topographic surveying system of the present invention according to an alternative embodiment of the present invention.

FIG. 4 is a geometrical diagram with side view of the hill road illustrating the accumulated height can be calculated on every length segments along the hill road.

FIG. 5 is a flow chart illustrating the method of the preferred embodiment of the present invention.

FIG. 6 is a flow chart illustrating the method of an alternative embodiment of the present invention.

FIG. 7 is a geometrical diagram with side view of the hill road illustrating the accumulated height can be calculated and combined with GPS position information along the hill road.

### DETAILED DESCRIPTION OF THE PREFERRED EMBODIMENTS

The following description is provided to enable any person skilled in the art to make and use the invention and sets forth the best modes contemplated by the inventors of carrying out their invention. Various modifications, however, will remain readily apparent to those skilled in the art.

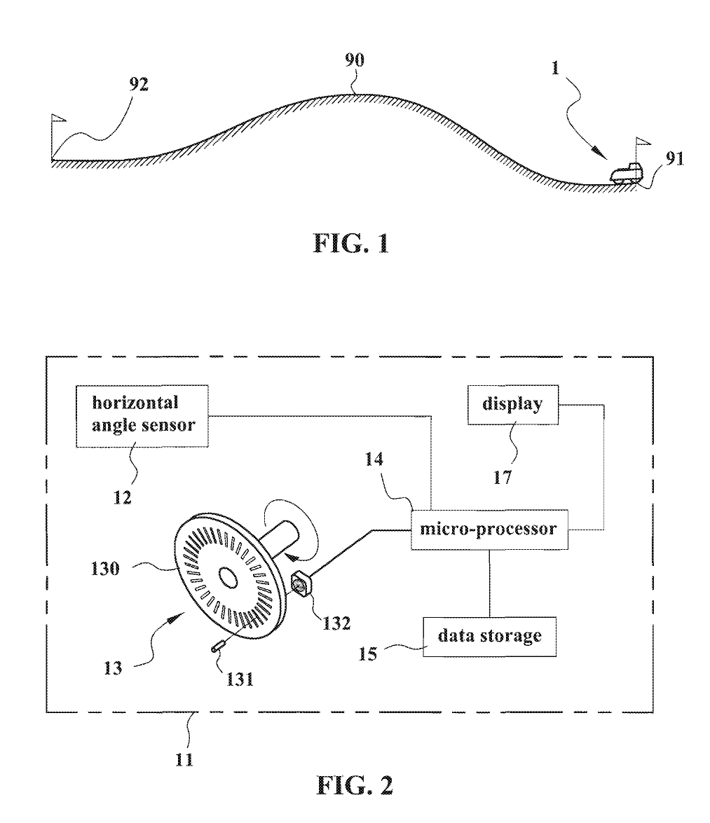

Turning to FIGS. 1 to 4, the road topographic surveying system 1 is used to moving along a hill road 90 that may permit to work in a tunnel, deep forest area and on an open site. Referring to FIG. 2, the road topographic surveying system may comprise at least a vehicle 11, a horizontal angle sensor 12, an encoder 13, a micro-processor 14, a data storage 16, and display 17.

The vehicle 11 moves from a start point 91 to an end point 92, typically has a wheel with a determined wheel radius (R) and rotatably engages with the road 90 and coupled with the encoder 13.

The encoder 13 generates a rotate signal to the micro-processor 14 at every predetermined graduations (n°) of the wheel rotation. The encoder 13 may be any traditional device for detecting the wheel rotation and generating the rotate signal at every predetermined graduations (n°) of the wheel rotation. The predetermined graduations (n°) may be selected from a range from one degree (1°) to three hundred and sixty degrees (360°) that the wheel moves the vehicle 11 a desired segment of moving length (ΔL) which is larger than one centimeter.

The encoder 13 may be coupled to the micro-processor 14 and comprise a grating disk 130 with grating slots, a light source 131 and a light detector 132. The grating disk 130 is driven by the wheel shaft (not shown) of the vehicle 11 directly or via a gear system. A light beam emits from the light source 131, passing through one of the grating slots to the light detector 132. The light detector 132 coupled to the micro-processor 14 detects the light beam and generate rotate signal to the micro-processor 14 at the predetermined graduations (n°).

The micro-processor 14 couples with the other elements of the system. Once the micro-processor 14 received a rotate signals, acquires a instantaneous horizontal angle value (α) from the horizontal angle sensor 12 thereby to calculate a segment of moving length (ΔL) and a segment of height (Δh), calculate an accumulated height (H), calculate an accumulated length (L) of a point, then stores the accumulated height (H) and length (L) in the data storage 16, and display all the accumulated lengths (L), instantaneous horizontal angle values (α) and the accumulated heights (H) in the display 17 correspondingly and sequentially.

The display 17 can be of any traditional LCD display, preferably, a touch-sensitive display for the operator to input the wheel radius value (R) in the system 1 and manipulate the moving and stop of the vehicle 11.

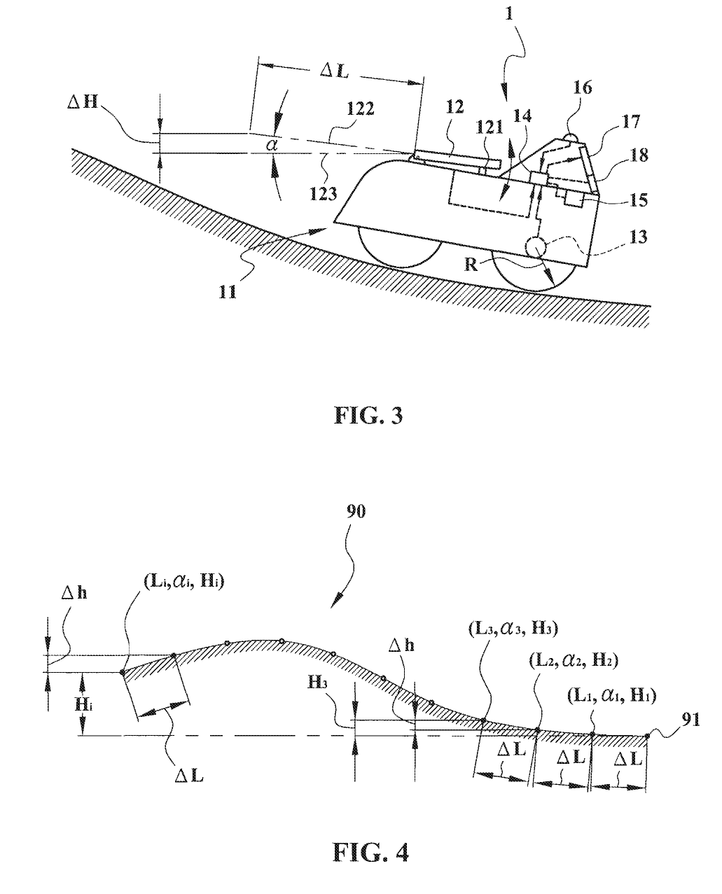

Turning now to FIG. 3, the road topographic surveying system 1 may further comprise an adjustment mechanism 121 for adjusting the axis 122 of the horizontal angle sensor 12 into a direction parallel to a horizontal plane 123, so as to set the instantaneous horizontal angle value (α) to be zero (0) at the start point 91 of the road 90.

The road topographic surveying system 1 may further comprise a GPS receiver 16 for acquiring the position information to combine with the accumulated lengths (L), the accumulated heights (H) and store in the data storage 15 point by point, correspondingly and sequentially. Such GPS receiver 16 may utilize signals from global positioning satellites as well as a differential signal from a local reference receiver of known position coordinates to generate position coordinate information to centimeter accuracy.

Preferably, the road topographic surveying system 1 may further comprise a key-input unit 18, including an interrupt button, a start button, a stop button, and/or a set of function buttons, a numerical keypad and an alphabet keypad. The operator may push the start button to moving the vehicle 11 at the start point 91, and push the stop button to terminate the operation of the system 1.

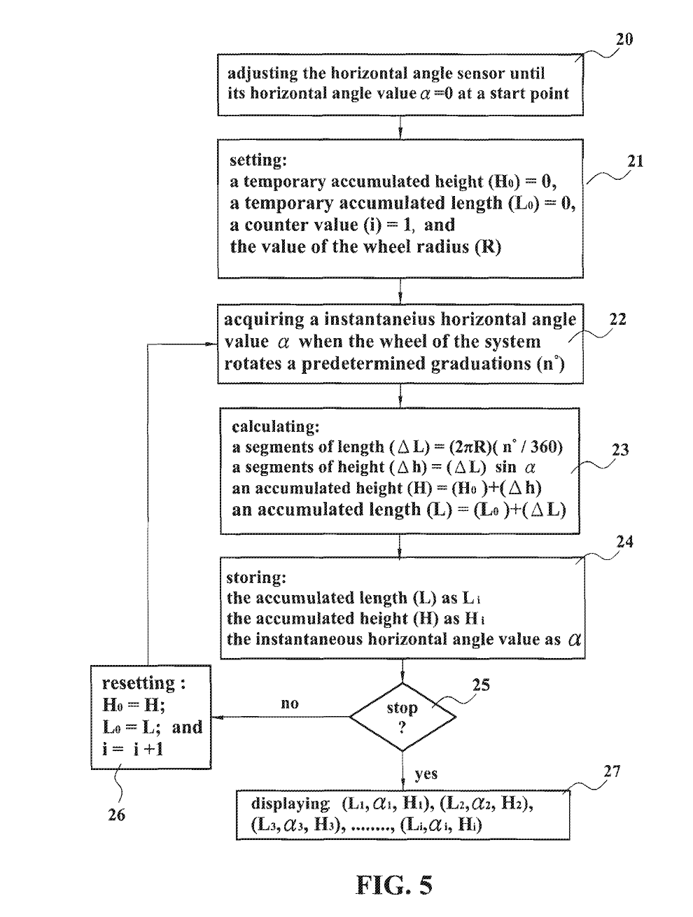

A method of the system 1 illustrated in FIG. 5 includes a step 20 for adjusting the horizontal angle sensor 12 until the instantaneous horizontal angle value (α) equals to zero (0) at the start point 91; a step 21, for setting a temporary accumulated height (H₀) to be zero (0), a temporary accumulated length (L₀) to be zero (0) and entering the wheel radius value (R) through a touch-sensitive display 17 or via a key-input unit 18 as described above; and setting a counter value (i) to be one (1) either automatically or semi-automatically by the micro-processor 14; a step 22 for acquiring an instantaneous horizontal angle value (α) by the micro-processor 14 from the horizontal angle sensor 12 when the micro-processor 14 receives the rotational signal which represents the wheel has rotated a predetermined graduations (n°); a step 23 for calculating the following value by the micro-processor 14:

a segment of length (ΔL)=(2πR)(n°/360);

a segment of height (Δh)=(ΔL)sin α;

an accumulated height (H)=(H₀); and

an accumulated length (L)=(L₀)+(ΔL);

a step 24 for storing the accumulated height (H) and the accumulated length (L) in the data storage 15 as Hᵢ and Lᵢ correspondingly and sequentially, in accordance with the counter value (i); a step 25 for determination of stop of the system 1, if it is not yet to stop, go step 26 for resetting the temporary accumulated height (H₀) equals to the accumulated height (H), the temporary accumulated length (L₀) equals to the accumulated length (L), the counter value (i) added by one (1); if in step 25, it is stopped by the operator with pushing a stop button of the key-input unit 18, the step 27 is displaying the position coordinates in the form of: (L₁, α₁, H₁), (L₂, α₂, H₂), (L₃, α₃, H₃) . . . , (Lᵢ, αᵢ, Hᵢ) on the display 17 and/or may be printed or plotted on a paper or suitable media as illustrated in FIG. 4.

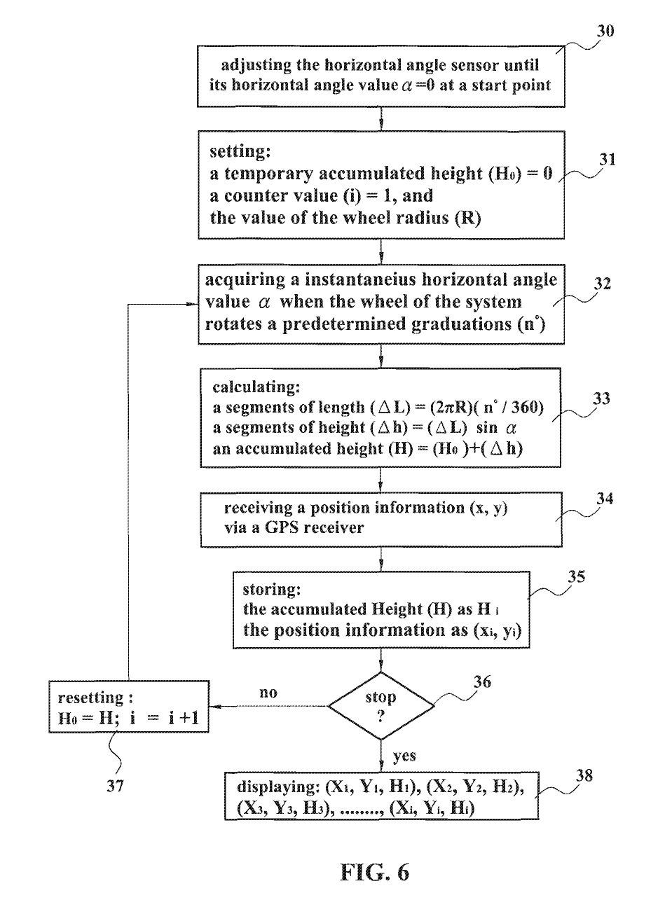

A slightly modified method of the system 1 for implementing the GPS receiver 16 for road topographic survey over an open site is illustrated in FIG. 6, which includes a step 30 for adjusting the horizontal angle sensor 12 until its horizontal angle value (α) equals to zero (0) at the start point 91 of the road 90; a step 31, for setting a temporary accumulated height (H₀) to be zero (0), entering the wheel radius value (R) through a touch-sensitive display 17 or via a key-input unit 18 as described above; and setting a counter value (i) to be one (1) either automatically or semi-automatically by the micro-processor 14; a step 32 for acquiring an instantaneous horizontal angle value (α) by the micro-processor 14 from the horizontal angle sensor 12 when the micro-processor 14 receives a rotational signal which represents the wheel has rotated a predetermined graduations (n°); a step 33 for calculating the following value by the micro-processor 14:

a segment of length (ΔL)=(2πR)(n°/360);

a segment of height (Δh)=(ΔL)sin α; and

an accumulated height (H)=(H₀);

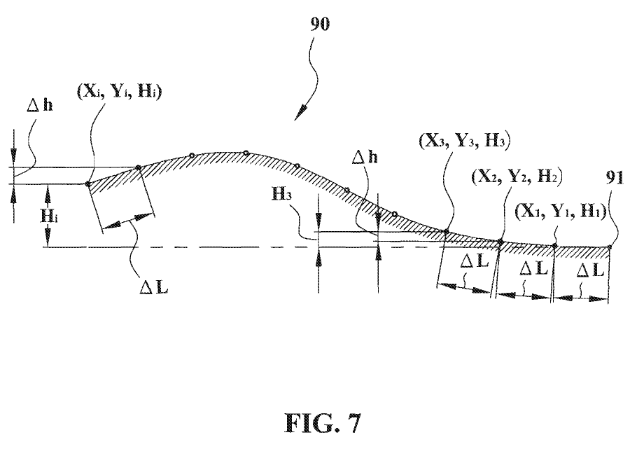

a step 34 for receiving an instantaneous position information via a GPS receiver 16; a step 35 for storing the accumulated height (H) in the data storage 15 as Hᵢ sequentially in accordance with the counter value (i); a step 25 for determination of stop, if it is not stopped, then go a step 37 for resetting the temporary accumulated height (H0) equals to the accumulated height (H), and let the counter value (i) added by one (1); if in step 36, it is stopped by the operator with pushing a stop button of the key-input unit 18, a step 38 is displaying the position coordinates in the form of: (X₁, Y₁, H₁), (X₂, Y₂, H₂), (X₃, Y₃, H₃) . . . , (Xᵢ, Yᵢ, Hᵢ) on the display 17 and/or may also be printed or plotted on a paper or suitable media as illustrated in FIG. 7.

Those skilled in the art will appreciate that various adaptations and modifications of the just-described preferred embodiment can be configured without departing from the scope and spirit of the invention. Therefore, it is to be understood that, within the scope of the appended claims, the invention may be practiced other than as specifically described herein.

What is claimed is:

1. A road topographic surveying system, comprising:
a vehicle, having at least a wheel with a radius (R) for moving the vehicle along a road with a plurality of segments of length (ΔL)=(2πR)(n°/360) at a plurality of predetermined graduations (n°);
a horizontal angle sensor, adjustably coupled to the vehicle for providing a instantaneously horizontal angle (α) at each said predetermined graduations (n°);
an encoder, coupled to the wheel for generating a rotate signals at each said predetermined graduations (n°);
a micro-processor, for calculating a segments of height (Δh) which equals to (ΔL) (sin α), an accumulated length (L) which equals to summation of the segments of length (ΔL) and an accumulated height (H) which equals to summation of the segments of height (Δh), when the micro-processor receives the rotate signal from the encoder; and
a data storage, for storing the accumulated lengths (L), instantaneously horizontal angle (α) and the accumulated heights (H) correspondingly and sequentially, when each time the micro-processor receives said rotate signals from the encoder.

2. The road topographic surveying system of claim 1 further comprises a display for displaying the accumulated lengths (L), the instantaneously horizontal angle (α) and the accumulated heights (H) correspondingly and sequentially.

3. The road topographic surveying system of claim 1 further comprises an adjustment mechanism for adjusting an axis of the horizontal angle sensor into a direction parallel to a horizontal plane at a start point of the road thereby to set the instantaneously horizontal angle (α) to be zero at a start point of the road.

4. The road topographic surveying system of claim 1, wherein the predetermined graduations (n°) is selected from a range from one degree (1°) to three hundred and sixty degrees (360°).

5. The road topographic surveying system of claim 1, wherein the encoder comprises a grating disk, a light source and a light detector.

6. The road topographic surveying system of claim 1 further comprises a touch-sensitive display for inputting and storing the radius (R) in the data storage.

7. The road topographic surveying system of claim 1 further comprises a key input unit having start button, interrupt button, stop button, alphabet and numerical keypad for manipulating the system and setting the radius (R) in the data storage.

8. The road topographic surveying system of claim 1 further comprises a GPS receiver for receiving and storing an instantaneous position information with the accumulated heights (H) correspondingly and sequentially, when the micro-processor receives the rotate signal from the encoder.

9. The road topographic surveying system of claim 1, wherein the segment of height (Δh) is calculated by (Δh)=(ΔL)sin α
